(19) United States
(12) Patent Application Publication
(10) Pub. No.: US 2025/0328254 A1
(43) Pub. Date: Oct. 23, 2025

(54) SYSTEM CONFIGURATION PROPOSAL APPARATUS, SYSTEM CONFIGURATION PROPOSAL METHOD, AND RECORDING MEDIUM

(71) Applicant: Hitachi Vantara, Ltd., Yokohama-shi (JP)

(72) Inventor: Keisuke ABE, Yokohama-shi (JP)

(21) Appl. No.: 19/077,375

(22) Filed: Mar. 12, 2025

(30) Foreign Application Priority Data
Apr. 23, 2024 (JP) 2024-069511

(51) Int. Cl. G06F 3/06

(52) U.S. Cl. CPC G06F 3/0617; G06F 3/0607; G06F 3/0685

(57) ABSTRACT

A server for proposing information related to a system configuration for a storage system to a user is provided. The server includes a processor and a memory, the memory is configured to store an availability correlation data table including availability level information related to an availability level for a plurality of storage systems, and the processor is configured to accept a condition including an availability level requested of a storage system by the user, identify a storage system candidate that satisfies the availability level included in the condition on the basis of the availability level information, and output information related to a system configuration for the identified storage system candidate.

### CROSS-REFERENCE TO PRIOR APPLICATION

This application relates to and claims the benefit of priority from Japanese Patent Application No. 2024-069511 filed on Apr. 23, 2024, the entire disclosure of which is incorporated herein by reference.

### BACKGROUND

The present invention relates to a technology for proposing a configuration for a storage system.

When building a storage system or considering operation thereof, it is important to ensure that the storage system can continuously operate, that is, to ensure availability thereof, but there is a shortage of skilled engineers capable of considering how to ensure availability.

For this reason, in recent years, there has been a demand for support that allows availability to be ensured without skilled engineers.

As a technology for proposing a configuration pattern for a storage system, the technology disclosed in Japanese Patent Application Publication No. 2020-008944 is known, for example.

According to the disclosure of Japanese Patent Application Publication No. 2020-008944, a system configuration pattern that satisfies the capacity as an essential condition is selected, the order of proposing is determined using evaluation weights and evaluation coefficients, and the result is proposed.

Furthermore, a technology of evaluating the reliability of a storage system is described for example in Tomohiro Kawaguchi and Hideo Saito, “Reliability Evaluation Method for High Availability Systems in Data Centers Using Markov Chains,” The IPSJ SIG Technical Report, vol. 2015-ARC-215 No. 9.

### SUMMARY

From the perspective of a storage system operator, the availability level is important as described above, and there is a demand for providing an appropriate system configuration on the basis of the availability level of the storage system.

With the foregoing in view, it is an object of the present invention to provide a technology that enables a storage system satisfying a specified availability level to be proposed easily and appropriately.

In order to achieve the object, a system configuration proposal apparatus according to one aspect proposes information related to a system configuration for a storage system to a user. The system configuration proposal apparatus includes a processor and a storage device. The storage device is configured to store availability level information related to an availability level for a plurality of storage systems. The processor is configured to accept a condition including an availability level requested of a storage system by the user, identify a storage system candidate that satisfies the availability level included in the condition on the basis of the availability level information, and output information related to a system configuration for the identified storage system candidate.

According to the present invention, a storage system that satisfies a specified availability level can be proposed easily and appropriately.

### BRIEF DESCRIPTION OF THE DRAWINGS

FIG. 1 is an overall configuration diagram of a computer system according to an embodiment;

FIG. 2 is a hardware configuration diagram of a server according to the embodiment;

FIG. 3 is a configuration diagram of a failure probability data table according to the embodiment;

FIG. 4 is a configuration diagram of a repair probability data table according to the embodiment;

FIG. 5 is a configuration diagram of a system model data table according to the embodiment;

FIG. 6 is a configuration diagram of an availability correlation data table according to the embodiment;

FIG. 7 is a graph indicating the relation between maintenance cycle and availability level in the availability correlation data table according to the embodiment;

FIG. 8 is a configuration diagram of an availability data table according to the embodiment;

FIG. 9 is a configuration diagram of a comparison result data table according to the embodiment;

FIG. 10 is a flowchart for illustrating system configuration proposal processing according to the embodiment;

FIG. 11 is a first diagram for illustrating system configuration proposal processing according to the embodiment;

FIG. 12 is a second diagram for illustrating the system configuration proposal processing according to the embodiment;

FIG. 13 is a third diagram for illustrating the system configuration proposal processing according to the embodiment;

FIG. 14 is a fourth diagram for illustrating the system configuration proposal processing according to the embodiment;

FIG. 15 is a fifth diagram for illustrating the system configuration proposal processing according to the embodiment;

FIG. 16 is a sixth diagram for illustrating configuration proposal processing according to the embodiment;

FIG. 17 is a diagram of a first example of a system configuration proposal screen according to the embodiment;

FIG. 18 is a diagram for illustrating input areas in the configuration proposal screen according to the embodiment;

FIG. 19 is a diagram of a second example of the configuration proposal screen according to the embodiment;

FIG. 20 is a diagram of a third example of the configuration proposal screen according to the embodiment;

FIG. 21 is a diagram of a fourth example of the configuration proposal screen according to the embodiment;

FIG. 22 is a diagram of a fifth example of the configuration proposal screen according to the embodiment; and

FIG. 23 is a diagram of a sixth example of the configuration proposal screen according to the embodiment.

### DETAILED DESCRIPTION OF THE EMBODIMENT

An embodiment will be described with reference to the drawings. It should be noted that the following description of the embodiment is not intended to limit the invention recited in the claims, and the elements in the description of the embodiment and all combinations thereof are not necessarily essential to the means for solution according to the invention.

In the following description, information may be described using the expression “AAA table,” but the information may be represented in any data structure. In other words, in order to indicate that the information is not dependent on a specific data structure, “AAA table” may be referred to as “AAA information.”

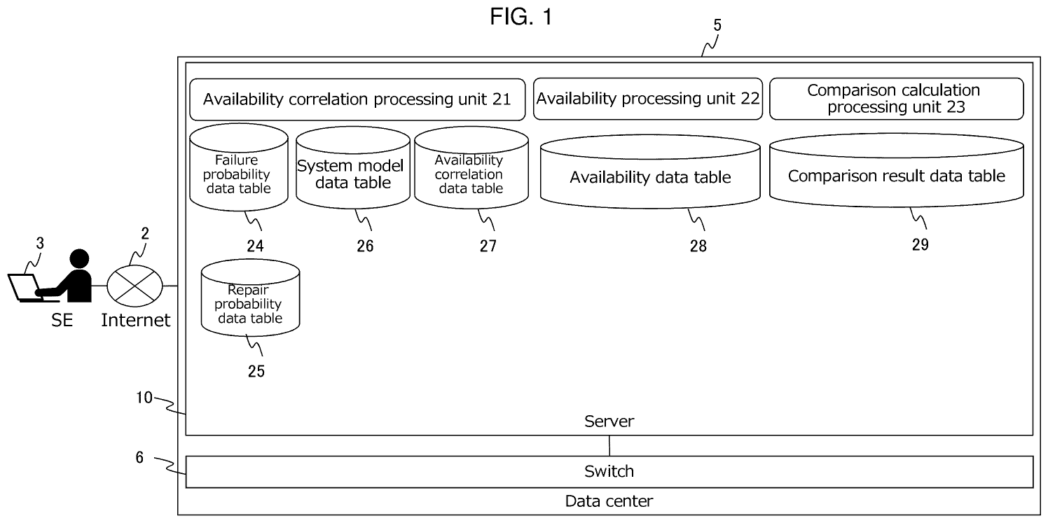

FIG. 1 is an overall configuration diagram of a computer system according to the embodiment.

The computer system 1 includes a terminal 3 and a data center 5. The terminal 3 and the data center 5 are coupled via the Internet 2 as an example of a network.

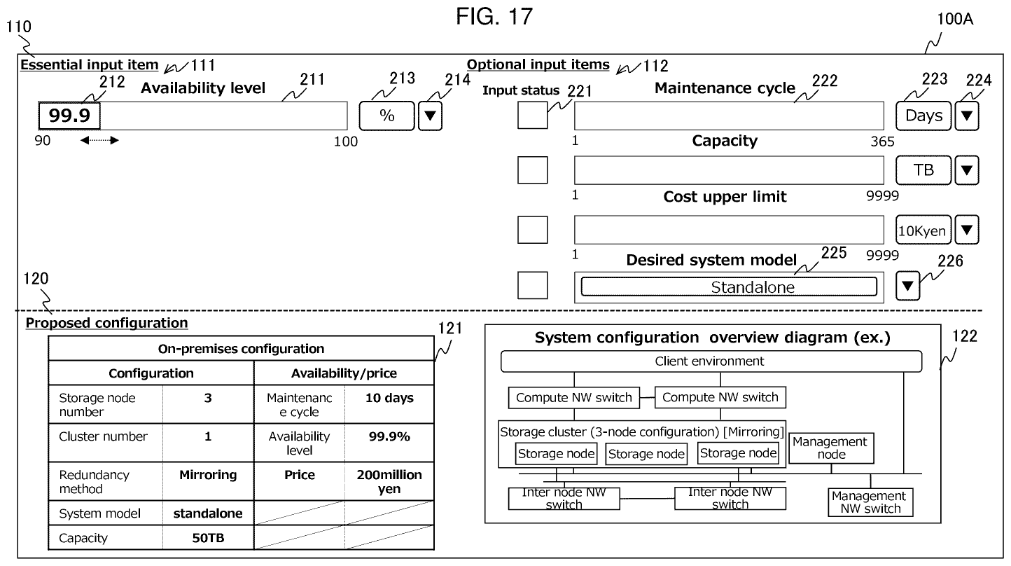

The terminal 3 is used by an SE (System Engineer) as an example of a user. The terminal 3 accepts input from the SE, such as a desired condition for a storage system, and displays a configuration proposal screen (see 100A to 100F in FIGS. 17 to 23) that outputs information related to the system configuration for the storage system that satisfies the condition.

The data center 5 has a switch 6 and a server 10. The switch 6 couples the server 10 to the Internet 2.

The server 10 is an example of the system configuration proposal apparatus and includes an availability correlation processing unit 21, an availability processing unit 22, a comparison calculation processing unit 23, a failure probability data table 24, a repair probability data table 25, a system model data table 26, an availability correlation data table 27, an availability data table 28, and a comparison result data table 29.

The availability correlation processing unit 21 performs processing to calculate availability levels for multiple storage systems on the basis of the failure probability data table 24, the repair probability data table 25, and the system model data table 26, and performs processing to update the availability correlation data table 27.

The availability processing unit 22 performs processing to select a storage system that satisfies input conditions with reference to the availability correlation data table 27, and to create the availability data table 28.

The comparison calculation processing unit 23 performs processing to select an optimal storage system with reference to the availability data table 28, store the result in the comparison result data table 29, and have the content of the proposal displayed on the configuration proposal screen (100A to 100F) on the basis of the comparison result data table 29.

Next, the hardware configuration of the server 10 will be described.

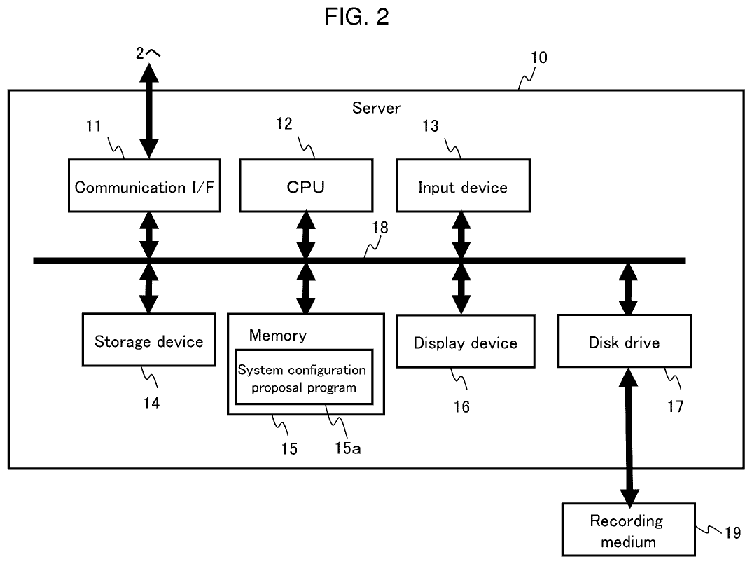

FIG. 2 is a hardware configuration diagram of the server according to the embodiment.

The server 10 is, for example, composed of a computer such as a general-purpose server. The server 10 includes a communication interface (I/F) 11, a CPU (Central Processing Unit) 12 as an example of a processor, an input device 13, a storage device 14, a memory 15 as an example of a storage device, a display device 16, and a disk drive 17. The communication I/F 11, the CPU 12, the input device 13, the storage device 14, the memory 15, the display device 16, and the disk drive 17 are coupled via the bus 18.

The communication I/F 11 is, for example, an interface such as a wired LAN card and a wireless LAN card and communicates with other apparatuses (e.g., the terminal 3) via the switch 6 and the Internet 2.

The CPU 12 executes various kinds of processing according to programs stored in the memory 15 and/or the storage device 14.

The memory 15 is, for example, a RAM (RANDOM ACCESS MEMORY) and stores programs to be executed by the CPU 12 and necessary information. In the embodiment, the memory 15 stores a system configuration proposal program 15a, the failure probability data table 24, the repair probability data table 25, the system model data table 26, the availability correlation data table 27, the availability data table 28, and the comparison result data table 29.

The storage device 14 is, for example, a hard disk or flash memory and stores programs to be executed by the CPU 12 and data to be used by the CPU 12.

The input device 13 is, for example, a mouse, a keyboard, and the like, and accepts input of information by the user of the server 10. The display device 16 is, for example, a display and displays and outputs screens including various kinds of information.

The disk drive 17 reads out programs and data recorded on the recording medium 19. The system configuration proposal program 15a stored in the memory 15 may be read out from the recording medium 19.

In the embodiment, the CPU 12 executes the system configuration proposal program 15a to configure the availability correlation processing unit 21, the availability processing unit 22, and the comparison calculation processing unit 23.

Next, the configuration of the failure probability data table 24 will be described.

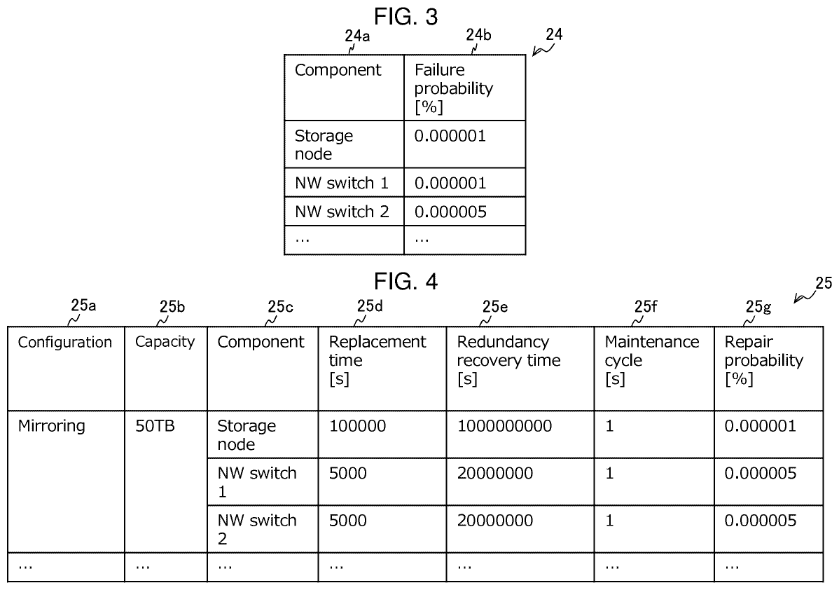

FIG. 3 is a configuration diagram of the failure probability data table according to the embodiment.

The failure probability data table 24 is an example of failure probability information and stores failure probabilities for the components that make up the storage system. The failure probability data table 24 stores an entry for each component. The entry in the failure probability data table 24 includes fields of a component 24a and a failure probability 24b. In the component 24a, the name of the component corresponding to the entry is stored. In the failure probability 24b, the failure probability for a prescribed period (e.g., per day) for the component corresponding to the entry is stored.

Next, the configuration of the repair probability data table 25 will be described.

FIG. 4 is a configuration diagram of the repair probability data table according to the embodiment.

The repair probability data table 25 stores the repair probabilities of components that constitute the storage system. Here, the repair probability refers to the probability that a component can be repaired. In the embodiment, the repair probability data table 25 stores the repair probabilities for multiple maintenance cycles for the configuration, capacity, and components of the storage system. The entry in the repair probability data table 25 includes fields of a configuration 25a, a capacity 25b, a component 25c, a replacement time 25d, a redundancy recovery time 25e, a maintenance cycle 25f, a repair probability 25g.

In the configuration 25a, the configuration of the redundancy of the storage system corresponding to the entry is stored. In the capacity 25b, the capacity of the storage system corresponding to the entry is stored. In the component 25c, the name of the component corresponding to the entry is stored. In the replacement time 25d, the time required to replace the component corresponding to the entry (replacement time) is stored. The replacement time is calculated for example on the basis of actual values for the storage system with the configuration and capacity corresponding to the entry. In the redundancy recovery time 25e, the time required for redundancy to be restored after a component is replaced in the storage system with the configuration and capacity corresponding to the entry (redundancy recovery time) is stored. The redundancy recovery time differs depending on the configuration and capacity. In the maintenance cycle 25f, the cycle (maintenance cycle) at which maintenance is performed on the component corresponding to the entry is stored. In the embodiment, entries corresponding to multiple maintenance cycles are stored for the same configuration, capacity, and component. In the repair probability 25g, the probability (repair probability) that the component corresponding to the entry is repaired within a prescribed period (e.g., per day) is stored. The repair probability can be calculated for example using the following expression (1).

$$Repair probability [ \% ] = 1 / ( replacement time + redundancy recovery time + ( maintenance cycle / 2 ) ) \qquad ( 1 )$$

In this embodiment, the maintenance cycle is divided by 2 to represent the average time.

In this example, the repair probability is stored in the repair probability data table 25, but instead of storing the repair probability in the repair probability data table, the repair probability may be calculated by using the expression (1) using the values stored in the repair probability data table.

Next, the configuration of the system model data table 26 will be described.

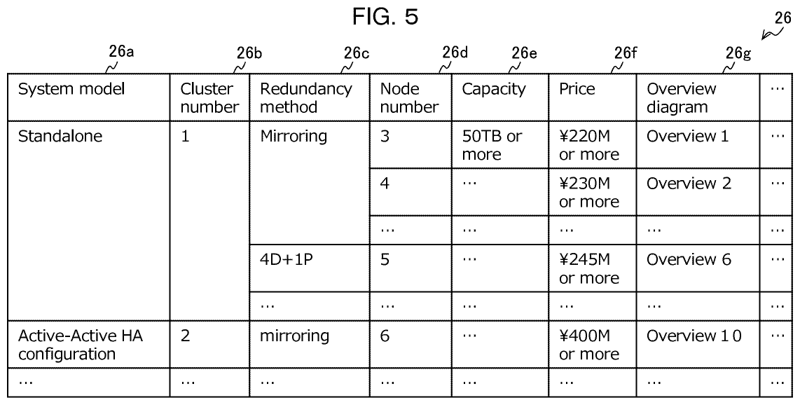

FIG. 5 is a configuration diagram of the system model data table according to the embodiment.

The system model data table 26 stores configuration information on a plurality of storage systems that can be implemented by the storage system. The system model data table 26 stores entries on a storage system basis. The entry in the system model data table 26 includes fields of a system model 26a, a cluster number 26b, a redundancy method 26c, a node number 26d, a capacity 26e, a price 26f, and an overview diagram 26g.

In the system model 26a, the type of system model corresponding to the entry is stored. The types of system models include a standalone system that is not connected to other systems, an asynchronous remote copy configuration, in which two storage clusters perform remote copying asynchronously, an Active-Active HA configuration, in which two duplicated storage clusters can be accessed simultaneously, and a hybrid cloud configuration, which includes an on-premises storage cluster and a cloud storage cluster. In the cluster number 26b, the number of clusters included in the storage system corresponding to the entry is stored. In the redundancy method 26c, the redundancy method in the storage system corresponding to the entry is stored. In the node number 26d, the number of storage nodes in the storage system corresponding to the entry is stored. In the capacity 26e, the capacity of the storage system corresponding to the entry is stored. In the price 26f, the price of the storage system corresponding to the entry is stored. Here, the price can be calculated for example with a function of the capacity. When the storage system is available as a one-time purchase, the price [yen]=capacity unit price [yen/GB]×capacity [GB] holds, and when the storage system is used on a subscription basis, the price [yen/month]=capacity unit price per month [yen/GB·month]×capacity [GB] holds. In the overview diagram 26g, either the data or a link of an overview diagram of the storage system corresponding to the entry is stored.

Next, the configuration of the availability correlation data table 27 will be described.

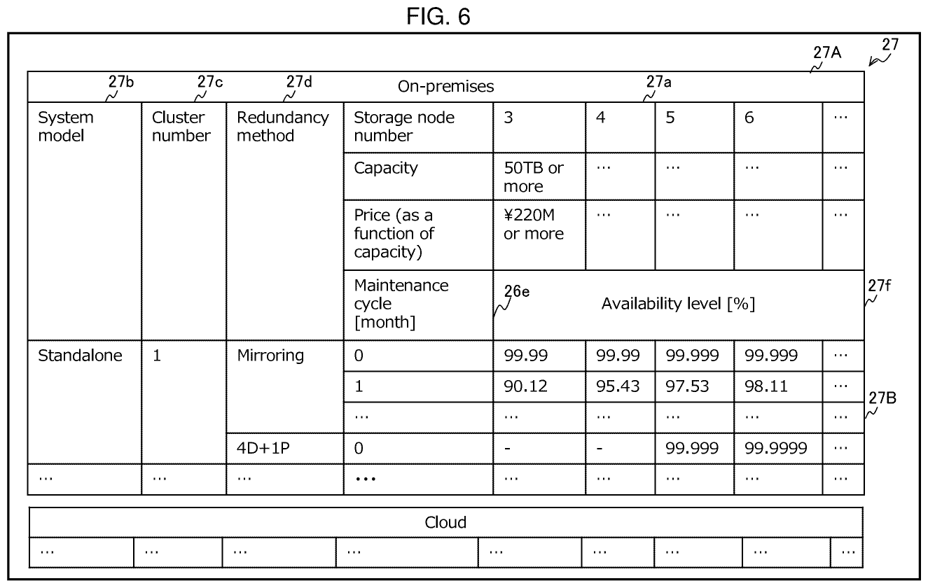

FIG. 6 is a configuration diagram of the availability correlation data table according to the embodiment.

The availability correlation data table 27 is an example of availability level information and includes an on-premises table 27A and a cloud table 27B. The on-premises table 27A and the cloud table 27B have similar configurations, and therefore, the on-premises table 27A will be described here.

The on-premises table 27A includes a part table 27a that manages the relation between the number of storage nodes and the capacity and price. As can be understood from the part table 27a, when for example the number of storage nodes is 3, the capacity is 50 TB or more and the price is ¥220 M (220 million yen) or more.

The on-premises table 27A includes fields of a system model 27b, a cluster number 27c, a redundancy method, 27d, a maintenance cycle 27e, and an availability level 27f. In the system model 27b, the type of system model corresponding to the entry is stored. In the cluster number 27c, the number of clusters included in the storage system corresponding to the entry is stored. In the redundancy method 27d, the redundancy method for the storage system corresponding to the entry is stored. In the maintenance cycle 27e, the maintenance cycle is stored. In the embodiment, one or more maintenance cycles are stored for one redundancy method. In the availability level 27f, the availability level for the number of corresponding storage nodes (in the same column) in the configuration corresponding to the entry is stored. As can be understood from the on-premises table 27A, when the system model is standalone, the number of clusters is 1, the redundancy method is Mirroring, and the maintenance cycle is one month, the availability level is 90.12 for three storage nodes and 95.43 for four storage nodes.

Next, the correspondence between the maintenance cycle and the availability level for each storage system according to the availability correlation data table 27 will be described.

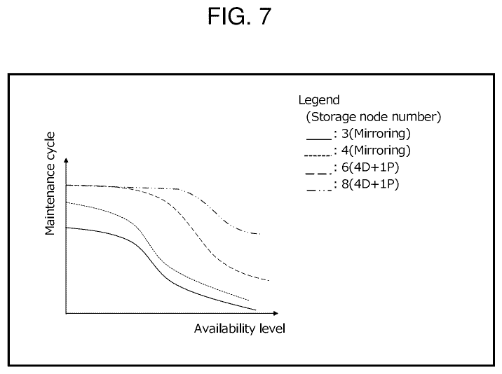

FIG. 7 is a graph showing the relation between the maintenance cycle and the availability level in the availability correlation data table according to the embodiment.

The information in the availability correlation data table 27 in FIG. 6 shows the correspondence between the maintenance cycle and the availability level for each storage system, as shown in FIG. 7. Therefore, according to the information in the availability correlation data table 27, the maintenance cycle that achieves a desired availability level for each storage system type can be specified.

Next, the configuration of the availability data table 28 will be described.

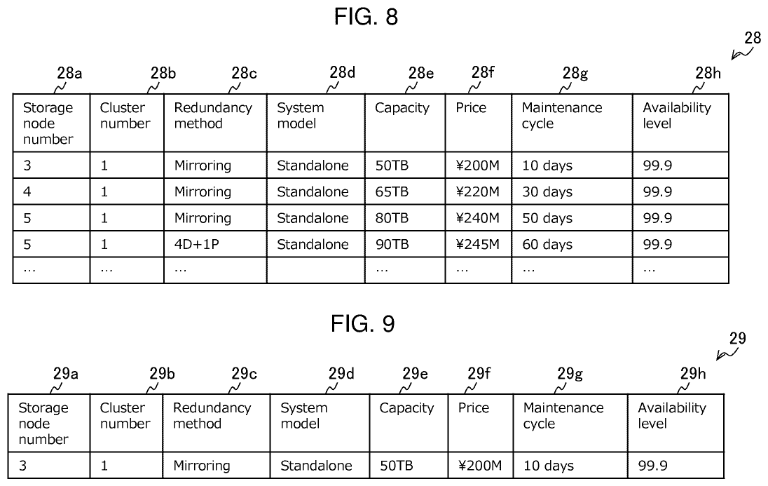

FIG. 8 is a configuration diagram of the availability data table according to the embodiment.

The availability data table 28 manages information such as the availability level of the storage system that satisfies input conditions. The availability data table 28 stores an entry for each storage system that satisfies the conditions. The entry in the availability data table 28 includes fields of a storage node number 28a, a cluster number 28b, a redundancy method 28c, a system model 28d, a capacity 28e, a price 28f, a maintenance cycle 28g, and an availability level 28h.

In the storage node number 28a, the number of storage nodes in the storage system corresponding to the entry is stored. In the cluster number 28b, the number of clusters included in the storage system corresponding to the entry is stored. In the redundancy method 28c, the redundancy method of the storage system corresponding to the entry is stored. In the system model 28d, the type of system model corresponding to the entry is stored. In the capacity 28e, the capacity of the storage system corresponding to the entry is stored. In the price 28f, the price of the storage system corresponding to the entry is stored. In the maintenance cycle 28g, the maintenance cycle of the storage system corresponding to the entry is stored. In the availability level 28h, the availability level of the storage system corresponding to the entry is stored.

Next, the configuration of the comparison result data table 29 will be described.

FIG. 9 is a configuration diagram of the comparison result data table according to the embodiment.

The comparison result data table 29 stores the entry for the storage system with the smaller number of storage nodes among the entries in the availability data table 28, or when there are multiple entries with the same number of storage nodes, the entry for the storage system with the lower price is stored. The entry in the comparison result data table 29 includes fields similar to those in the availability data table 28.

Next, the system configuration proposal processing for server 10 will be described.

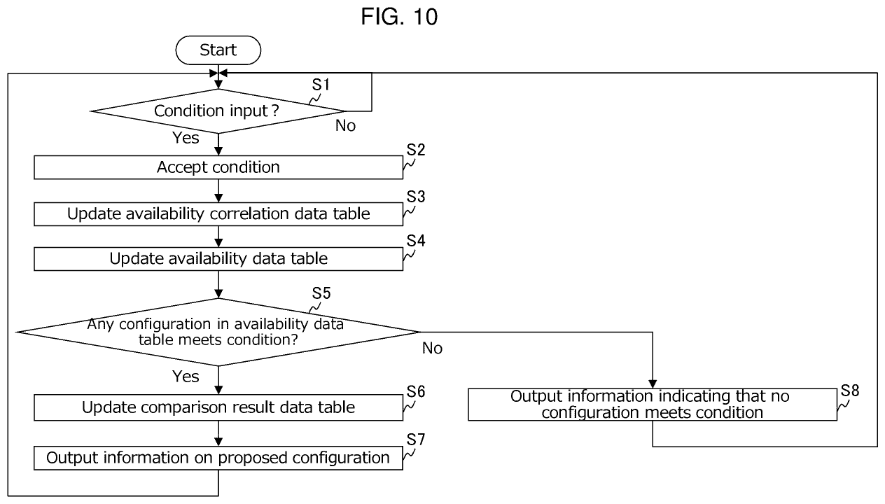

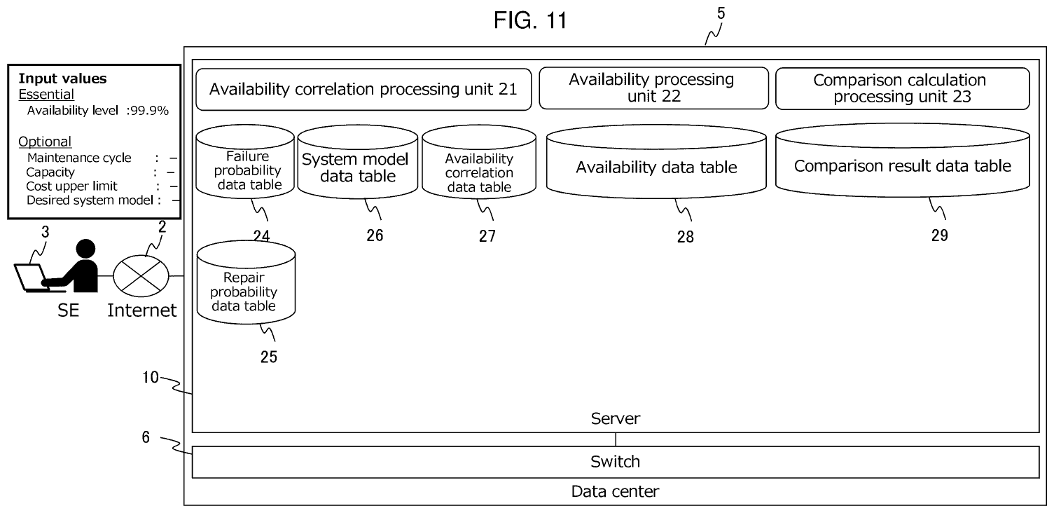

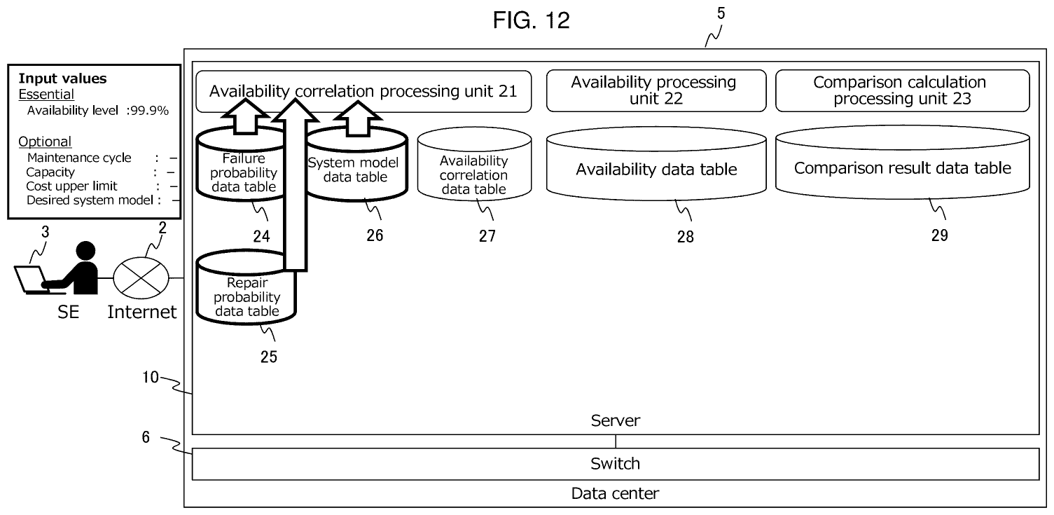

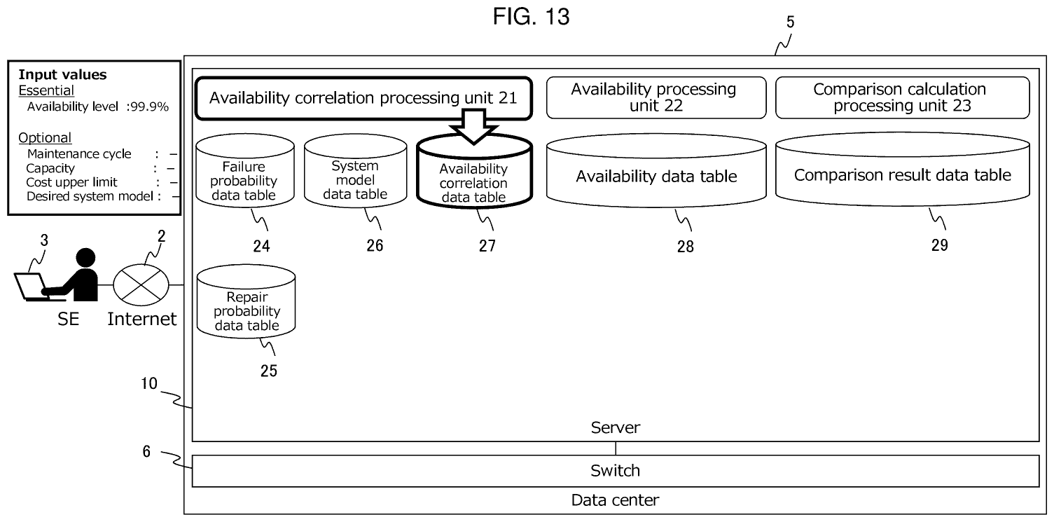

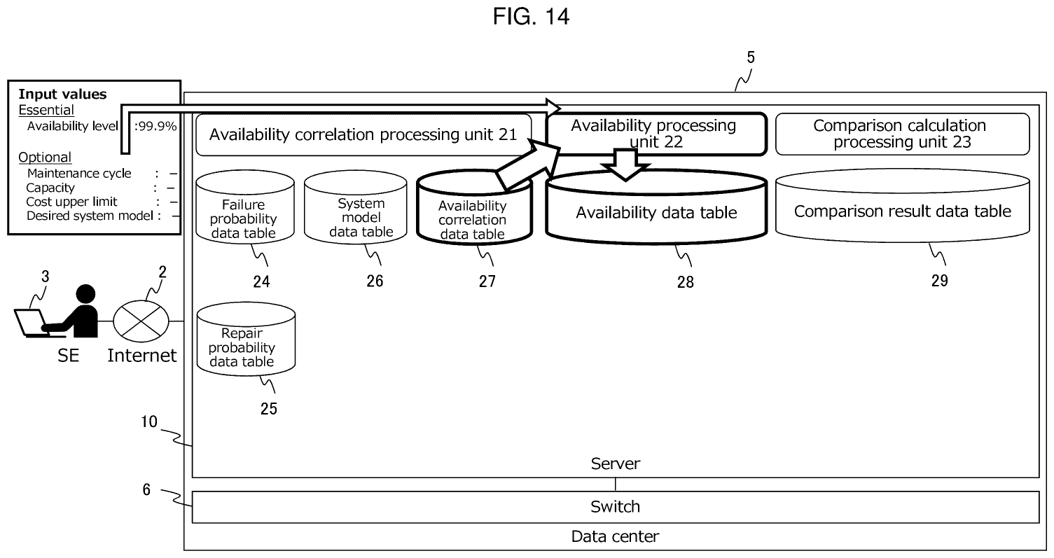

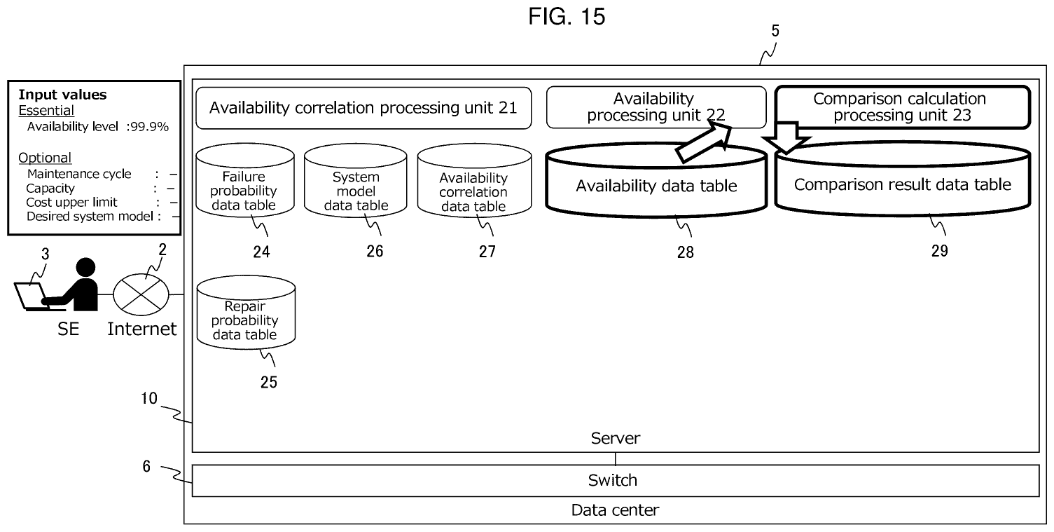

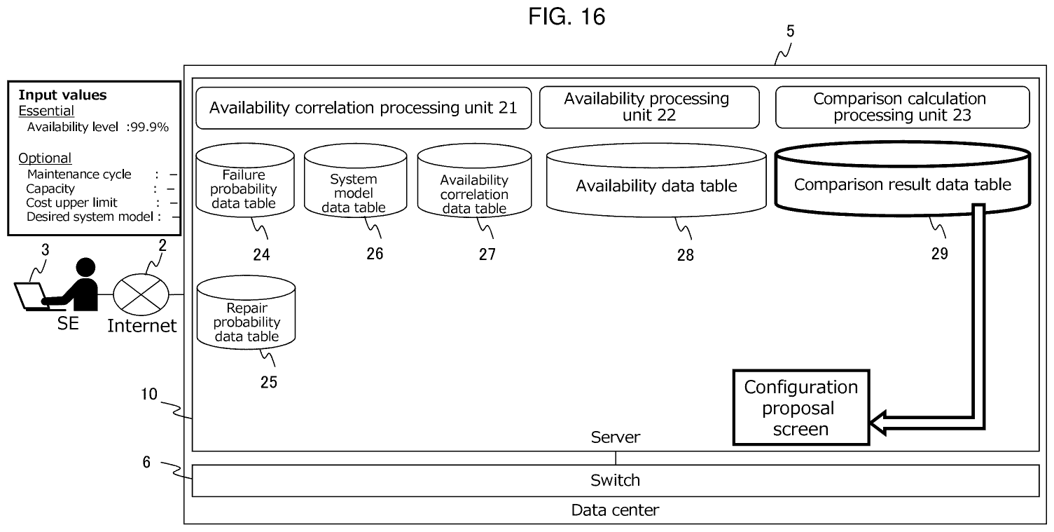

FIG. 10 is a flowchart for illustrating system configuration proposal processing according to an embodiment. FIG. 11 is a first diagram for illustrating the system configuration proposal processing according to the embodiment, FIG. 12 is a second diagram for illustrating the system configuration proposal processing according to the embodiment, FIG. 13 is a third diagram for illustrating the system configuration proposal processing according to the embodiment, FIG. 14 is a fourth diagram for illustrating the system configuration proposal processing according to the embodiment, FIG. 15 is a fifth diagram for illustrating the system configuration proposal processing according to the embodiment, and FIG. 16 is a sixth diagram for illustrating the system configuration proposal processing according to the embodiment.

In the system configuration proposal processing, the availability correlation processing unit 21 determines whether the conditions (input values) for the desired storage system input from the terminal 3 have been received, as shown in FIG. 11 (S1). As a result, if the conditions have not been received (S1: No), the availability correlation processing unit 21 advances the process to step S1.

Meanwhile, if the conditions have been received (S1: Yes), the availability correlation processing unit 21 accepts the received conditions (S2).

Then, the availability correlation processing unit 21 reads the failure probability data table 24, the repair probability data table 25, and the system model data table 26, as shown in FIG. 12, and updates the availability correlation data table 27 on the basis of these tables, as shown in FIG. 13 (S3). In this processing, the availability correlation processing unit 21 executes the processing to calculate the availability level in each storage system.

Here, the method for calculating the availability level in each storage system will be described.

In this embodiment, an absorbing Markov chain model is used. A Markov chain is a model that represents probabilistic transitions from one state to another, expressing the probability of moving from the current state to the next state. An absorbing Markov chain is a type of chain where, once a specific state is reached, a state is “absorbed” into the state and no longer moves to other states. By using an absorbing Markov chain model in this way, the expected time from the initial state to the absorbing state can be calculated.

Specifically, the possible states for the storage system configuration are enumerated, and the transition probabilities between arbitrary states among these states are expressed using the failure probabilities and repair probabilities of components occurring per unit time to create an absorbing Markov chain model. In this case, the states of data loss and system shutdown are treated as absorbing states that cannot transition to other states. In other words, these states are states that transition to the same states with a probability of 1. The values in the failure probability data table 24 are used for the failure probabilities. The values in the repair probability data table 25 are used for the repair probabilities. Then, the availability level is calculated by calculating the expected time from the initial state to the absorbing state using the absorbing Markov chain model and taking the reciprocal of the expected time. For example, by using the corresponding repair probability for each maintenance cycle for a storage system with the same system configuration, the availability level for each maintenance cycle in the storage system can be calculated.

Then, the availability processing unit 22 refers to the availability correlation data table 27 as shown in FIG. 14 and registers, in the availability data table 28, an entry for a storage system that satisfies the accepted conditions (S4).

Then, the comparison calculation processing unit 23 determines whether there is an entry with a configuration that satisfies the conditions in the availability data table 28 (S5).

As a result, if there is such an entry in the availability data table 28 (S5: Yes), the comparison calculation processing unit 23 specifies, from the availability data table 28, an appropriate storage system entry such as an entry for a storage system with fewer storage nodes, stores it in the comparison result data table 29 (S6), and displays a configuration proposal screen (100A, 100B, 100D to 100F) that includes information on the configuration of the storage system on the basis of the comparison result data table 29 (S7), and the process proceeds to step S1. Thereafter, whenever a condition is input (changed) on the configuration proposal screen, the subsequent steps are executed, and processing to update the configuration proposal screen in real time is executed.

Meanwhile, if there is no such entry in the availability data table 28 (S5: No), the comparison calculation processing unit 23 displays a configuration proposal screen (e.g., 100C) that includes information indicating that there is no configuration that satisfies the conditions (S8), and the process proceeds to step S1.

Next, an example of the configuration proposal screen displayed by the comparison calculation processing unit 23 will be described.

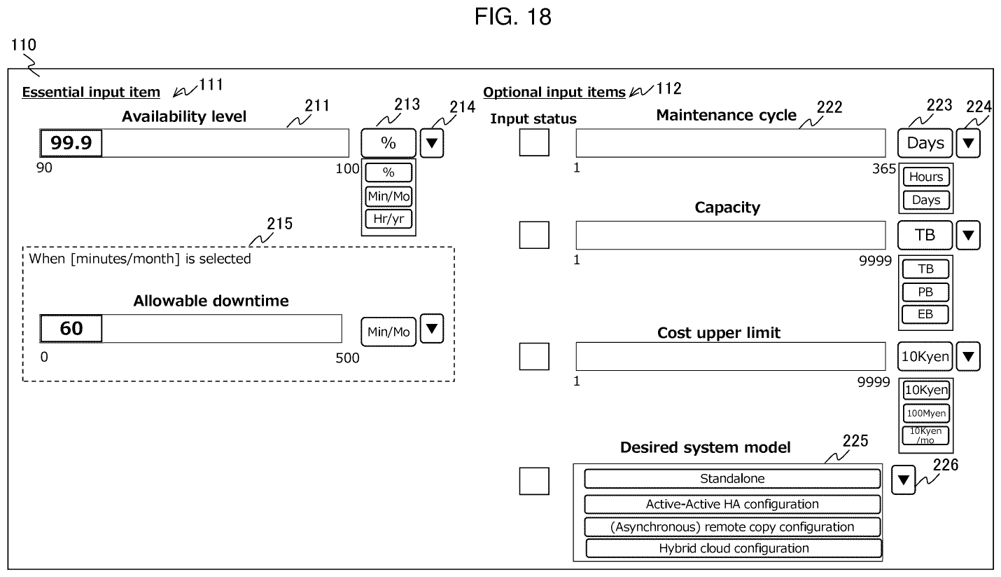

FIG. 17 shows a first example of the configuration proposal screen according to the embodiment. FIG. 18 shows an input area for the configuration proposal screen according to the embodiment. The configuration proposal screen 100A shown in FIG. 17 is an example of a configuration proposal screen displayed when only an essential input item is specified as a condition, for example, when the availability level is specified as 99.9%.

The configuration proposal screen 100A includes an input area 110 and a proposed configuration display area 120. The input area 110 is an area in which the user inputs a condition for a desired storage system and includes an essential input item area 111 and an optional input item area 112.

The essential input item area 111 is an area for entering an essential condition. In the embodiment, the essential condition is the availability level.

The essential input item area 111 includes a gauge 211, a unit selection area 213, and a candidate display button 214. The gauge 211 displays an availability level value in a specifiable manner, and the minimum and maximum values that can be specified are displayed. The gauge 211 includes a bar 212 that indicates a specified value. The bar 212 displays the specified availability level value. The user can easily change the specified availability level by changing the size of the bar 212 using an input device. In the embodiment, when the specified availability level is changed, the system configuration proposal processing is executed, and the display content in the proposed configuration display area 120 is updated in real time.

In the unit selection area 213, the selected unit for the availability level is displayed. The candidate display button 214 is used to accept the display of the selectable units for the availability level. When the candidate display button 214 is pressed, multiple candidate units is displayed in the unit selection area 213, as shown in FIG. 18.

For example, in to the embodiment, when “minutes/month” or “hours/year” is selected in the unit selection area 213, the input area 215 for allowable downtime, which is an example of availability level, is displayed as shown in FIG. 18.

The optional input item area 112 is an area for entering conditions that can be specified arbitrarily by the user. In the embodiment, examples of the optional condition include a maintenance cycle, a capacity, a cost upper limit, and a desired system model, but other conditions may also be included.

The optional input item area 112 has an input area for each of the optional conditions. In the optional input item area 112, the input area for conditions to select values includes, for example, an input status 221, a gauge 222, a unit selection area 223, and a candidate display button 224. The input status 221 is an area for specifying whether to input the corresponding optional condition, that is, whether to specify it as a condition. The gauge 222 displays a value for the condition in a specifiable manner, and the minimum and maximum values that can be specified are displayed. The gauge 222 includes a bar that indicates the specified value. The user can easily change the value of the condition by changing the size of the bar using the input device.

In the unit selection area 223, the selected unit for the condition is displayed. The candidate display button 224 is for accepting the display of the selectable unit for the condition. When the candidate display button 224 is pressed, displays multiple candidate units is displayed in the unit selection area 223, as shown in FIG. 18. For example, in the input area for the cost upper limit condition, the unit selection area allows for selection among units of cost such as “ten thousand yen” (“10 Kyen”) or “ten million yen” (“100 Myen”) for a one-time purchase among units of cost for subscription, such as “ten thousand yen (“10 Kyen”)/month.”

In the optional input item area 112, in the input area for a condition to select a candidate, such as specifying a desired system model, the candidate selection area 225 and the candidate display button 226 are displayed. In the candidate selection area 225, candidates selected for the condition is displayed. The candidate display button 226 is button for accepting the display of selectable units for the condition.

When the candidate display button 226 is pressed, the selectable candidates are displayed in the candidate selection area 225, as shown in FIG. 18. For example, in the input area for the system model type condition, multiple selectable candidates such as “standalone,” “Active-Active HA configuration,” “(Asynchronous) remote copy configuration,” and “Hybrid cloud configuration.” are displayed in the candidate selection area.

In the proposed configuration display area 120, information about the storage system proposed as a storage system that satisfies the conditions, or information provided to the user when there is no storage system that satisfies the conditions is displayed. In the proposed configuration display area 120, a detailed display area 121 and an overview diagram display area 122 are displayed. The detailed display area 121 is an area that displays details about the proposed storage system. For example, in the detailed display area 121, information stored in the comparison result data table 29, specifically, the type of storage system, the number of storage nodes, the number of clusters, the redundancy method, the capacity, the maintenance cycle, the availability level, and the price are displayed. In the overview diagram display area 122, an example of an overview diagram of the configuration of the proposed storage system is displayed. The overview diagram can be obtained, for example, by referring to the system model data table 26.

Next, a second example of the configuration proposal screen will be described.

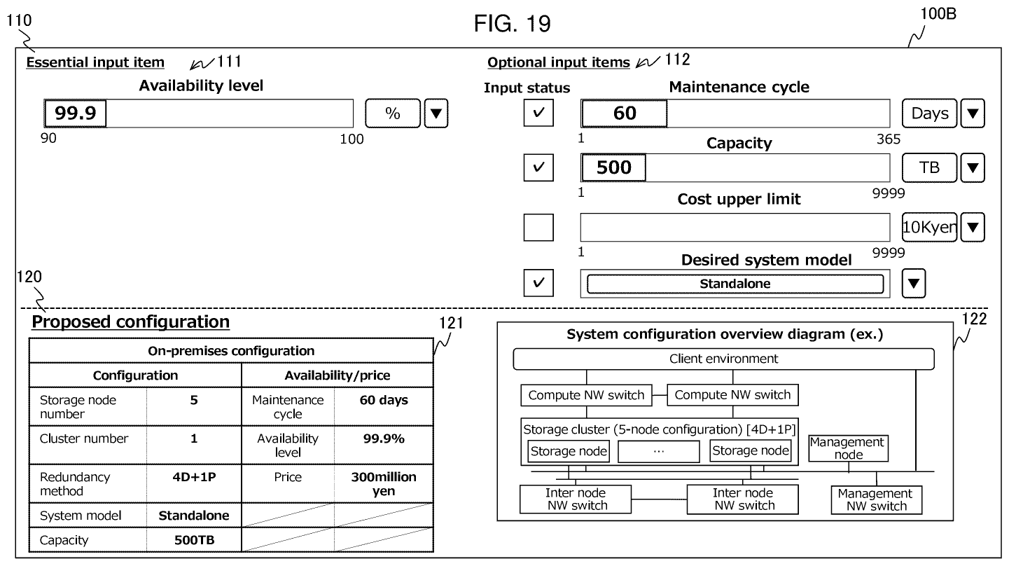

FIG. 19 shows the second example of the configuration proposal screen according to the embodiment.

The configuration proposal screen 100B is a screen displayed when conditions are entered, where the availability level is 99.9%, the maintenance cycle is 60 days, the capacity is 500 TB, and the type of system model is standalone.

In this example, since a storage system that satisfies the input conditions has been detected, the detailed display area 121 for the storage system that satisfies the input conditions is displayed in the proposed configuration display area 120, and the corresponding overview diagram is displayed in the overview diagram display area 122.

Next, a third example of the configuration proposal screen will be described.

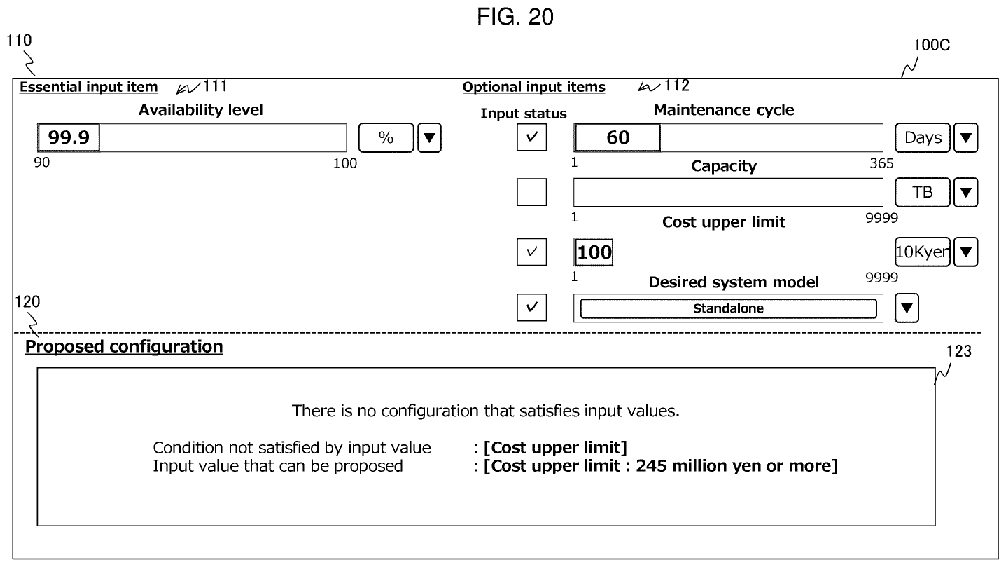

FIG. 20 shows the third example of the configuration proposal screen according to the embodiment.

The configuration proposal screen 100C is a screen displayed when the conditions are entered, where the availability level is 99.9%, the maintenance cycle is 60 days, the cost upper limit is one million yen, and the system model type is standalone.

In this example, since no storage system that satisfies the entered conditions has been detected, a condition modification proposal 123 is displayed in the proposed configuration display area 120. The condition modification proposal 123 includes information indicating that no configuration satisfies the entered values, the kinds of conditions that cannot be satisfied, and the input values that can be proposed, that is, the values that meet the specified conditions.

According to the configuration proposal screen 100C, when the conditions are not met, it is possible to identify easily and appropriately which conditions are not satisfied and how the conditions should be modified to find a storage system that satisfies the conditions.

Next, a fourth example of the configuration proposal screen will be described.

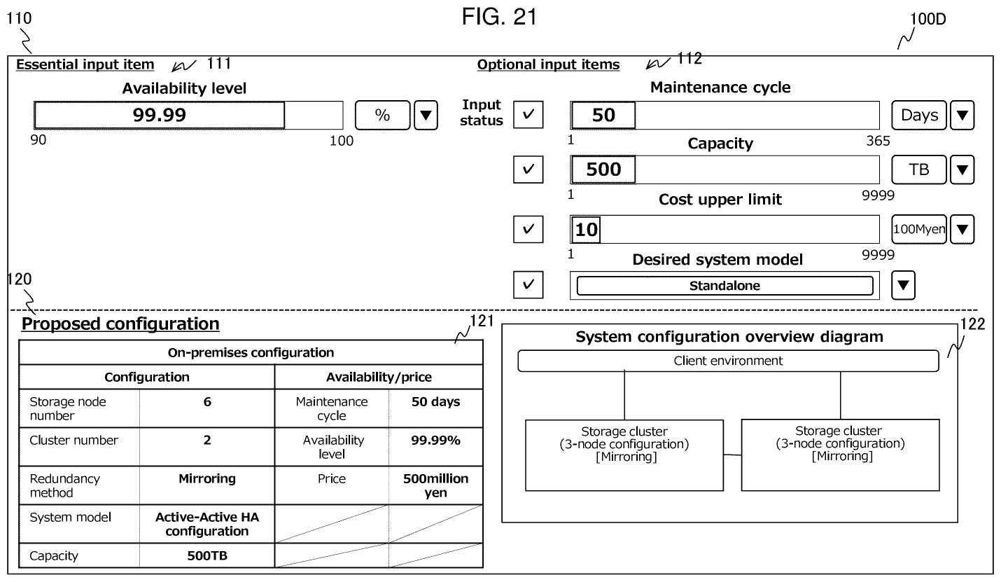

FIG. 21 shows the fourth example of the configuration proposal screen according to the embodiment.

The configuration proposal screen 100D is displayed when the conditions are input, where the availability level is 99.99%, the maintenance cycle is 50 days, the capacity is 500 TB, the cost condition is one billion yen, and the system model type is standalone.

In this example, no storage system that satisfies the input conditions has been found, but a configuration that can be achieved by changing only the system model type has been found. In the proposed configuration display area 120, as shown in FIG. 20, the detailed display area 121 is displayed for the storage system that satisfies the conditions other than the system model type, instead of displaying the condition modification proposal 123, and the corresponding overview diagram is displayed in the overview diagram display area 122.

Next, a fifth example of the configuration proposal screen will be described.

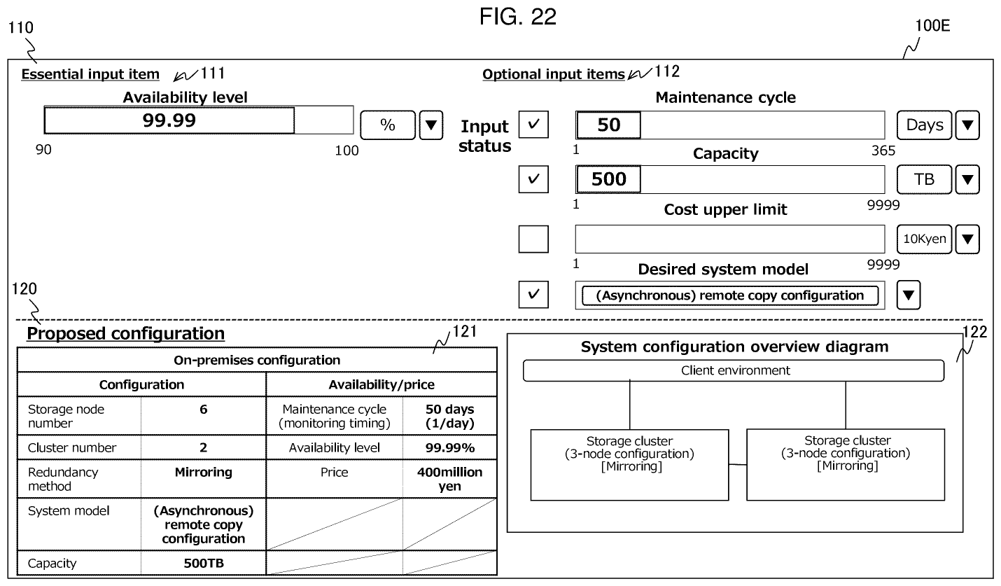

FIG. 22 shows the fifth example of the configuration proposal screen according to the embodiment.

The configuration proposal screen 100E is displayed when the conditions are entered, where the availability level is 99.99%, the maintenance cycle is 50 days, the capacity is 500 TB, and the type of system model is (asynchronous) remote copy configuration.

In this example, since a storage system that satisfies the input conditions has been detected, the detailed display area 121 for the storage system that satisfies the input conditions is displayed in the proposed configuration display area 120, and the corresponding overview diagram is displayed in the overview diagram display area 122. Note that if the storage system has a (asynchronous) remote copy configuration, as automatic failover function does not work, monitoring timing information is added and displayed in the maintenance cycle in the detailed display area 121.

Next, a sixth example of the configuration proposal screen will be described.

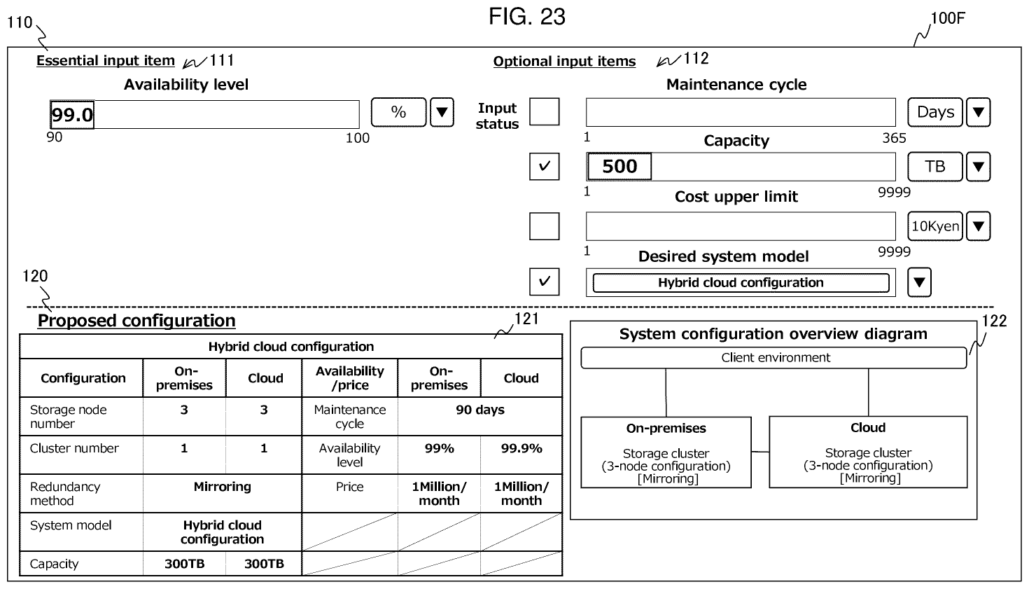

FIG. 23 shows the sixth example of the configuration proposal screen according to the embodiment.

The configuration proposal screen 100F is displayed when the conditions are input, where the availability level is 99.0%, the capacity is 500 TB, and the system model type is a hybrid cloud configuration.

In this example, since a storage system that satisfies the input conditions has been detected, the detailed display area 121 for the storage system that satisfies the input conditions is displayed in the proposed configuration display area 120, and the corresponding overview diagram is displayed in the overview diagram display area 122. In this example, as the detected storage system is a hybrid cloud, the detailed display area 121 includes information such as the configuration, the availability level, and the price on the on-premises side as well as information such as the configuration, the availability level, and the price on the cloud side.

Note that the present invention is not limited to the embodiment described above and can be modified as appropriate and implemented without departing from the spirit of the invention.

For example, in the embodiment described above, the availability correlation data table 27 is created on the server 10, but the invention is not limited to this, and it is also possible to store the availability correlation data created in advance.

In addition, although in the above description of the embodiment, a single storage system that satisfies the conditions is proposed, multiple storage systems that satisfy the conditions can be proposed. In this case, it is sufficient to display information on multiple storage systems on the basis of the information in the availability data table 28, and it is also possible to display the priority based on the number of storage nodes for the multiple storage systems.

In addition, in the above embodiment, it is also possible to perform part or all of the processing performed by the CPU using hardware circuits.

What is claimed is:

1. A system configuration proposal apparatus for proposing information related to a system configuration for a storage system to a user,
the system configuration proposal apparatus comprising a processor and a storage device, wherein
the storage device is configured to store availability level information related to an availability level for a plurality of storage systems, and
the processor is configured to
accept a condition including an availability level requested of a storage system by the user,
identify a storage system candidate that satisfies the availability level included in the condition on the basis of the availability level information, and
output information related to a system configuration for the identified storage system candidate.

2. The system configuration proposal apparatus according to claim 1, wherein the storage device includes, as the availability level information related to the availability level, information regarding a maintenance cycle in the storage system and the availability level during the maintenance cycle.

3. The system configuration proposal apparatus according to claim 2, wherein
the condition includes a maintenance cycle requested of the storage system, and
the processor is configured to identify a storage system candidate that satisfies the availability level and the maintenance cycle included in the condition.

4. The system configuration proposal apparatus according to claim 1, wherein
the condition includes a system model type requested of the storage system, and
the processor is configured to identify a storage system candidate that satisfies the availability level and the system model type included in the condition.

5. The system configuration proposal apparatus according to claim 1, wherein the system model type includes a hybrid cloud that includes an on-premises storage cluster and a cloud storage cluster.

6. The system configuration proposal apparatus according to claim 1, wherein the information related to the system configuration for the storage system candidate includes an overview diagram of the system configuration for the storage system candidate.

7. The system configuration proposal apparatus according to claim 1, wherein
the storage device is configured to store failure probability information related to failure probabilities about a plurality of components that constitute a plurality storage systems and configuration information related to system configurations in the plurality of storage systems, and
the processor is configured to
estimate an availability level for each of the storage systems on the basis of the failure probability information and the configuration information and
store in the storage device the estimated availability level as the availability level information.

8. The system configuration proposal apparatus according to claim 1, wherein the processor is configured to,
when there is no storage system candidate that satisfies the condition, identify a kind of condition that is not satisfied and a content for the kind of the condition that can be satisfied and
output the kind of the condition and the content of the condition.

9. The system configuration proposal apparatus according to claim 1, wherein the processor is configured to,
when there are a plurality of storage system candidates that satisfy the availability level included in the condition, output a less costly storage system candidate with priority from among the plurality of storage system candidates.

10. The system configuration proposal apparatus according to claim 1, wherein the processor is configured to
accept change of the availability level, and
update and output, in real time, information related to a system configuration for a storage system candidate that satisfies the accepted availability level.

11. A system configuration proposal method performed by a system configuration proposal apparatus for proposing information related to a system configuration for a storage system to a user, the method comprising:
storing availability level information related to an availability level for a plurality of storage systems;
accepting a condition including an availability level requested of a storage system by the user;
identifying a storage system candidate that satisfies the availability level included in the condition on the basis of the availability level; and
outputting information related to a system configuration for the identified storage system candidate.

12. A recording medium store a system configuration proposal program to be executed by a computer for proposing information related to a system configuration for a storage system to a user,
the computer being configured to store availability level information related to an availability level for a plurality of storage systems, and
the system configuration proposal program causing the computer to:
accept a condition including an availability level requested of a storage system by the user;
identify a storage system candidate that satisfies the availability level included in the condition on the basis of the availability level information; and
output information related to a system configuration for the identified storage system candidate.
